(19) United States
(12) Patent Application Publication
(10) Pub. No.: US 2026/0289988 A1
(43) Pub. Date: Sep. 24, 2026

(54) IMAGE SIGNAL PROCESSOR FOR SEMANTIC SEGMENTATION

(71) Applicant: KOREA ADVANCED INSTITUTE OF SCIENCE AND TECHNOLOGY, Daejeon (KR)

(72) Inventors: Hoi-Jun YOO, Daejeon (KR); Jongjun PARK, Daejeon (KR)

(73) Assignee: KOREA ADVANCED INSTITUTE OF SCIENCE AND TECHNOLOGY, Daejeon (KR)

(21) Appl. No.: 19/276,435

(22) Filed: Jul. 22, 2025

(30) Foreign Application Priority Data
Mar. 18, 2025 (KR) 10-2025-0034805

(51) Int. Cl. G06V 10/82; G06T 9/00; G06V 10/26

(52) U.S. Cl. CPC G06V 10/82; G06T 9/002; G06V 10/26

(57) ABSTRACT

An image signal processor includes a network interface, a convolution core, and a core cluster. The network interface is configured to receive image data. The convolution core is configured to perform convolution operations on the image data to generate an intermediate feature map including chunks. The core cluster is configured to perform matrix multiplication between the intermediate feature map and weights. The core cluster includes a compression encoder and cores. The compression encoder is configured to compress first positional bits of each of the chunks into first data based on run-length encoding and compress second positional bits lower than the first positional bits into second data based on an encoding different from the run-length encoding. The cores are configured to reuse results of certain operations in the matrix multiplication between the first positional bits and the weights, during other operations of the matrix multiplication, based on the first data.

### CROSS-REFERENCE TO RELATED APPLICATIONS

This application claims priority to and benefits of Korean Patent Application No. 10-2025-0034805 under 35 U.S. C § 119, filed on Mar. 18, 2025, in the Korean Intellectual Property Office, the contents of which are incorporated herein in its entirety by reference.

### BACKGROUND

### 1. Technical Field

The present disclosure relates to an image signal processor, and more particularly, to an image signal processor configured to perform image segmentation based on deep neural networks.

### 2. Description of the Related Art

An image signal processor is a hardware or software module configured to process digital image and video signals. Such image signal processors may be provided to image sensors in various electronic devices. For example, image sensors can be widely used in electronic devices such as smartphones, tablets, laptops, desktops, and televisions, imaging devices such as digital cameras, transportation means such as automobiles, security systems such as CCTV, and medical equipment such as CT, MRI, and endoscopes. Recently, deep neural network-based image signal processors have been employed to run applications in various devices equipped with image sensors.

The image signal processor may be configured to perform semantic segmentation. Semantic segmentation, which is a technique for extracting object classes and pixel-level locations from camera input, is widely utilized in the field of computer vision. Image segmentation technology is applied in augmented reality (AR), 3D reconstruction for metaverse applications, decision-making applications requiring interaction with the physical world such as robotic navigation, and context-aware monitoring applications such as behavior recognition and object tracking. Hardware for image acceleration requires high frame rates. However, in devices with battery constraints such as mobile devices, such hardware is also required to maintain low power consumption.

### SUMMARY

The present disclosure aims to provide an image signal processor configured to reduce memory bandwidth requirements and decrease energy consumption for memory access through a chunk-based bit plane compression scheme.

The present disclosure also aims to provide an image signal processor configured to improve computational throughput, processing speed, and energy efficiency by skipping computations based on similarity.

An image signal processor according to an embodiment of the present disclosure includes a network interface, a convolution core, and a core cluster. The network interface is configured to receive image data. The convolution core is configured to perform convolution operations on the image data to generate an intermediate feature map including chunks. The core cluster is configured to perform matrix multiplication between the intermediate feature map and weights. The core cluster includes a compression encoder and a plurality of cores. The compression encoder is configured to compress first positional bits of each chunk into first data based on run-length encoding and to compress second positional bits, which are lower than the first positional bits, into second data based on an encoding different from the run-length encoding. The cores are configured to reuse results of certain operations in the matrix multiplication between the first positional bits and the weights, based on the first data, during other operations of the matrix multiplication.

In an example, the compression encoder may include a high bit encoder configured to generate the first data including length information representing a number of consecutive identical values at respective positions of the first positional bits, and a low bit encoder configured to generate the second data including representative values, each corresponding to the most frequent value at respective positions of the second positional bits.

In an example, each chunk may have a size dependent on the number of channels inputted in parallel to each of the cores. The length information may include a number of consecutively input identical bit values, at a particular position of the first positional bits, for a particular channel among the channels.

In an example, the first positional bits may correspond to upper half bits of the bit count of each chunk, and the second positional bits may correspond to lower half bits.

In an example, the core cluster may further include a compression decoder configured to decode the first data into the first positional bits of the intermediate feature map and concatenate the decoded first data with the second data.

In an example, each core may include: a fetcher configured to generate a skip control signal for reuse based on the first data, receive the first and second data from the compression encoder, and selectively output either the first data or the second data; and a processing element configured to receive the first or second data from the fetcher, perform matrix multiplication between the received data and the weights, and skip certain operations during the matrix multiplication based on the skip control signal.

In an example, the fetcher may be configured to store the first data including length information representing a number of consecutive identical values at each position of the first positional bits, determine a skip range based on the length information at the position having the smallest value among the first positional bits, and generate the skip control signal corresponding to the skip range.

In an example, the processing element may be configured to separate the first data into a sign part and a magnitude part, perform an XOR operation between the sign part and a sign part of the weights, perform a multiplication between the magnitude part and a magnitude part of the weights, and combine the results of the XOR operation and the multiplication.

In an example, the processing element may be configured to perform multiplication between the second data and the weights and append a sign bit to the result of the multiplication.

In an example, each core may be configured to receive the first and second data corresponding respectively to the channels from the compression encoder, generate a skip signal corresponding to a specific channel among the channels based on the first data, and skip at least a part of matrix multiplication operations corresponding to the specific channel based on the skip signal.

According to an embodiment of the present disclosure, the image signal processor may reduce energy consumption for data access by compressing the intermediate feature map using a chunk-based bit plane compression scheme.

According to an embodiment of the present disclosure, the image signal processor may improve the throughput, processing speed, and energy efficiency of matrix multiplication operations in a deep neural network by skipping computations based on similarity.

### BRIEF DESCRIPTION OF THE DRAWINGS

These and/or other features will become apparent and more readily appreciated from the following description of the embodiments, taken in conjunction with the accompanying drawings.

FIG. 1 is a block diagram of an image signal processor according to an embodiment of the present disclosure.

FIG. 2 is a diagram illustrating an exemplary configuration of the compression encoder shown in FIG. 1.

FIG. 3 is a diagram illustrating a chunk-based compression operation of the compression encoder shown in FIG. 2.

FIG. 4 is a diagram illustrating an exemplary configuration of the compression decoder shown in FIG. 1.

FIG. 5 is a diagram illustrating an exemplary configuration of a core shown in FIG. 1.

FIG. 6 is a diagram illustrating an exemplary configuration of a fetcher shown in FIG. 5.

FIG. 7 is a diagram illustrating an exemplary configuration of a processing element shown in FIG. 5.

FIG. 8 is a diagram illustrating an exemplary configuration of an operation skip controller shown in FIG. 5.

FIG. 9 is a diagram illustrating a similarity-based skip operation performed by the core shown in FIG. 5.

FIG. 10 is a diagram illustrating a coarse skip operation performed by the core shown in FIG. 5.

FIG. 11 is a diagram illustrating a fine skip operation performed by the core shown in FIG. 5.

FIGS. 12A and 12B are graphs illustrating computational efficiency resulting from compression and skip operations according to the present disclosure.

### DETAILED DESCRIPTION

Hereinafter, certain embodiments of the present disclosure will be described in more detail with reference to the accompanying drawings. In the drawings, the proportions and dimensions of components may be exaggerated for clarity and ease of explanation.

Any expressions such as “comprise” or “include” are intended to specify the presence of features, integers, steps, operations, elements, components, or combinations thereof stated in the specification, and shall not be construed to preclude any possibility of presence or addition of one or more other features, integers, steps, operations, elements, components, or combinations thereof.

Furthermore, when a component is described as being “on” another component, it may be located above or below the other component and does not necessarily imply being positioned on the upper side in the direction of gravity.

When a component is described as being “connected” or “coupled” to another component, it may be directly connected or coupled to the other component or indirectly connected or coupled via another component.

Terms such as “first” and “second” may be used when referring to components, but these terms are intended only for distinguishing one component from another and do not imply any limitation on the nature, order, or sequence of the components.

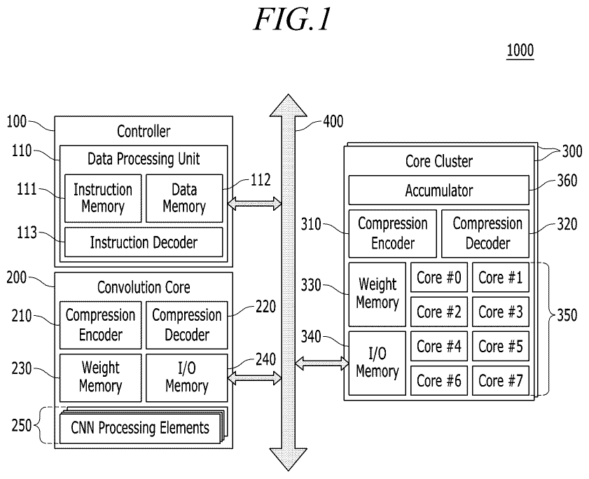

FIG. 1 is a block diagram of an image signal processor according to an embodiment of the present disclosure. Referring to FIG. 1, an image signal processor 1000 includes a controller 100, a convolution core 200, a core cluster 300, and a network interface 400. The configuration of the image signal processor 1000 shown in FIG. 1 is illustrative and not intended to limit the scope of the disclosure as long as the functions of the present disclosure can be implemented. For example, at least some of the components of the image signal processor 1000 may be integrated into a single unit, or at least part of the functions performed by each component may be performed by other components. For instance, the convolution core 200 and the core cluster 300 may be configured as an integrated component within the image signal processor 1000.

The image signal processor 1000 may be configured to perform semantic segmentation for understanding the content of an image. To this end, the image signal processor 1000 may implement a Mixed Transformer (MiT) model by combining convolution operations with attention operations of a vision transformer model. The image signal processor 1000 may implement the MiT model using a deep neural network-based algorithm.

The controller 100 may be configured to manage the overall operation of the image signal processor 1000. The controller 100 may serve as a top-level controller of the image signal processor 1000. The controller 100 may perform control for image processing operations such as image segmentation. To this end, the controller 100 may be configured to manage instructions for the convolution core 200 and the core cluster 300 and control data communication through the network interface 400. The controller 100 includes a data processing unit 110.

The data processing unit 110 may be configured to manage instructions and data for image processing operations. To this end, the data processing unit 110 includes an instruction memory 111, a data memory 112, and an instruction decoder 113. The instruction memory 111 may store instructions for performing functions such as image segmentation. The data memory 112 may store data required for performing functions such as image segmentation. The instruction decoder 113 may interpret instructions for image processing operations and generate control signals so that the convolution core 200 and the core cluster 300 perform operations corresponding to the instructions. For example, such control signals may be stored in the data memory 112 and provided to the convolution core 200 and the core cluster 300 via the network interface 400.

The convolution core 200 may be configured to perform convolution operations on image data or an intermediate feature map derived from intermediate processing of the image data. For example, the convolution core 200 may also support operations such as stride convolution and depthwise convolution. The convolution core 200 may generate the intermediate feature map by recognizing image boundaries or patterns. To this end, the convolution core 200 may include a compression encoder 210, a compression decoder 220, a weight memory 230, an input/output memory 240, and convolution neural network (CNN) processing elements 250.

The compression encoder 210 may be configured to encode and compress image data or an intermediate feature map. The compression decoder 220 may be configured to decode the compressed image data or intermediate feature map. The compression encoder 210 and the compression decoder 220 may perform encoding and decoding in substantially the same manner as the compression encoder 310 and the compression decoder 320 of the core cluster 300, which will be described later. By performing the same encoding and decoding operations, the convolution core 200 and the core cluster 300 may facilitate efficient communication and processing of data. An operational pipeline may be formed between the convolution core 200 and the core cluster 300 for vertical data processing.

The weight memory 230 may be configured to store weights used for convolution operations. The input/output memory 240 may be configured to store image data or intermediate feature maps for performing convolution operations. The input/output memory 240 may communicate with other components, such as the core cluster 300, through the network interface 400.

The CNN processing elements 250 may be configured to perform convolution operations between kernel weights stored in the weight memory 230 and image data or intermediate feature maps stored in the input/output memory 240. The CNN processing elements 250 may utilize a weight-stationary data flow for performing operations. For example, the CNN processing elements 250 may include sixteen processing elements (16×16) configured for 1×16 convolution operations. In this case, the weight memory 230 may have 16 KB of storage space for storing kernel weights, and the input/output memory 240 may have 32 KB of storage space for storing input/output data such as image data or intermediate feature maps.

The core cluster 300 may be configured to perform attention operations on the intermediate feature map. Through attention operations, the core cluster 300 may assign weights to the feature map to emphasize features relevant to tasks such as image segmentation. The core cluster 300 may perform the attention operations in a manner that emphasizes important information in the intermediate feature map by considering overall context and other factors. To this end, the core cluster 300 may include a compression encoder 310, a compression decoder 320, a weight memory 330, an input/output memory 340, and cores 350. Although multiple core clusters 300 may be employed, the present disclosure is not limited thereto.

The compression encoder 310 may be configured to partition the intermediate feature map into chunks and compress the intermediate feature map in bit plane units based on bit positions. To improve the compression ratio of the intermediate feature map, the compression encoder 310 may compress upper positional bits (first positional bits) using run-length encoding and compress lower positional bits (second positional bits) by representing them with a representative value corresponding to the most frequent value. In other words, the first positional bits, which exhibit high spatial locality, may be compressed using run-length encoding, while the second positional bits, which have low sensitivity to noise, may be compressed by substitution with representative values. This enables enhancement of the compression ratio while avoiding critical degradation of data quality resulting from compression. Further details will be described below.

The compression decoder 320 may be configured to decode the intermediate feature map that was compressed by the compression encoder 310. Similar to the compression encoder 310, the compression decoder 320 may separately decompress the upper positional bits and the lower positional bits. For example, the compression decoder 320 may decompress the compressed first positional bits using run-length decoding and concatenate the decompressed first positional bits with the compressed second positional bits. Further details will be described below.

The weight memory 330 may be configured to store weights used for the attention operations. The input/output memory 340 may be configured to store image data or intermediate feature maps for performing the attention operations. The input/output memory 340 may communicate with other components, such as the convolution core 200, through the network interface 400.

The cores 350 may be configured to perform attention operations between weights stored in the weight memory 330 and the compressed intermediate feature map or image data. The cores 350 may receive the intermediate feature map compressed by the compression encoder 310 and perform multiply-accumulate (MAC) operations without decoding. During this process, the cores 350 may reference length information corresponding to consecutive positions derived from run-length encoding, consider the similarity within the intermediate feature map, and skip parts of the matrix multiplication in the attention operation. Accordingly, the core cluster 300 may improve both the processing speed and power efficiency of the attention operation. Further details will be described below.

In an example, the cores 350 may be configured as eight units, in which case the weight memory 330 may have 64 KB of storage space, and the input/output memory 340 may have 36 KB of storage space. Each of the cores 350 may include 4×32 processing elements and four fetchers. The cores 350 may be connected to four input channels and receive data in parallel. Each channel may be connected to one fetcher and thirty-two processing elements. It shall be understood that this specific configuration of the cores 350 is provided for illustrative purposes only.

An accumulator 360 may be configured to accumulate the computation results of the cores 350. The accumulated results may be delivered to the input/output memory 340 as a subsequent feature map (e.g., a second intermediate feature map). The second intermediate feature map may be compressed by the compression encoder 310 and stored in the input/output memory 340 and may later be decompressed by the compression decoder 320 for self-attention layer operations.

The network interface 400 may be configured to facilitate data communication among the controller 100, the convolution core 200, and the core cluster 300. The network interface 400 may be configured to receive image data from an external source, for example, from a camera of an electronic device. In an example, the network interface 400 may electrically connect an external interface (not shown) and internal components of the image signal processor 1000 through a network-on-chip.

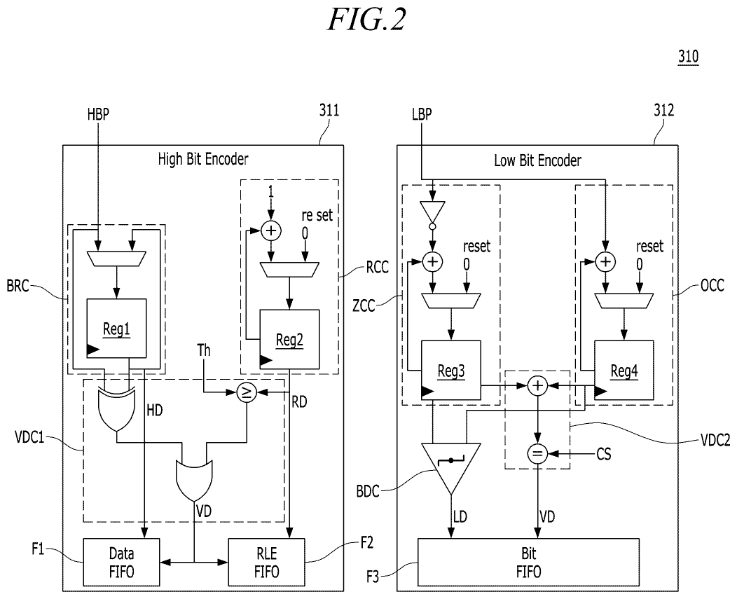

FIG. 2 is a diagram illustrating an exemplary configuration of the compression encoder shown in FIG. 1. The compression encoder 310 of FIG. 2 corresponds to the compression encoder 310 of the core cluster 300 shown in FIG. 1. Furthermore, the compression encoder 310 of FIG. 2 also corresponds to the compression encoder 210 of the convolution core 200 shown in FIG. 1. Referring to FIG. 2, the compression encoder 310 includes a high bit encoder 311 and a low bit encoder 312.

The high bit encoder 311 is configured to receive the high bit plane (HBP) of the intermediate feature map. The intermediate feature map is divided into chunks, and the size of each chunk depends on the number of channels connected to each of the cores 350 in FIG. 1 that receive data in parallel. For example, if one core is connected to four channels and the designated bit sequence size of a chunk is five, then the chunk size may be 4×5. The high bit plane (HBP) includes the upper bits that are greater than half of the total number of bits in each chunk. For instance, if the number of input bits per channel is eight, the HBP may include the upper four bits.

Although a single high bit encoder 311 is illustrated, a plurality of high bit encoders 311 may be provided. As exemplified in FIG. 1, the number of cores 350 may be eight, and each core 350 may be connected to four channels. In this case, the number of high bit encoders 311 may be thirty-two. The high bit encoders 311 may compress bit sequences corresponding to different bit positions (e.g., the upper four bit positions). In practice, the bits input to the high bit encoder 311 shown in FIG. 2 may be understood as bit sequences corresponding to a particular position among multiple positions.

The high bit encoder 311 stores a previous bit value of the high bit plane HBP through a bit register circuit BRC that includes a first register Reg1. If the bit value stored in the first register Reg1 differs from the currently input bit value, the stored bit value HD in the first register Reg1 is updated to the current value. The previous bit value and the current bit value may be subjected to an XOR operation in a first validity detection circuit VDC1. If the previous and current bit values differ, a valid signal VD is output to a data FIFO F1 through an OR gate. The valid signal VD may be understood as a signal that determines whether data should be stored in the data FIFO F1. Based on the valid signal VD, the bit value HD stored in the first register Reg1 is stored in the data FIFO F1. In other words, a continuous bit sequence may be terminated, and transition of the bit may be made.

The high bit encoder 311 counts the length of consecutive identical values in the high bit plane HBP through a run-length count circuit RCC. A second register Reg2 stores the run-length count value RD. Each time the same value continues in the high bit plane HBP, the run-length count value RD is incremented by one. When the input value of the high bit plane HBP changes, the run-length count value RD is reset, and the run-length count value RD before the reset is stored in a run-length (RLE) FIFO F2 based on a valid signal VD generated from the XOR operation in the first validity detection circuit VDC1.

The high bit encoder 311 may account for cases in which the input values of the high bit plane HBP remain unchanged, based on the first validity detection circuit VDC1. When the run-length count value RD exceeds a threshold Th corresponding to the maximum continuous length of a chunk, the first validity detection circuit VDC1 may generate a valid signal VD to store data in the data FIFO F1 and the run-length FIFO F2.

The low bit encoder 312 is configured to receive the low bit plane LBP of the intermediate feature map. The low bit plane LBP includes bits that are lower than half the total number of bits in each chunk. For example, if the number of input bits per channel is eight, the low bit plane LBP may include the lower four bits. A plurality of low bit encoders 312 may be provided, similar to the high bit encoders 311. For instance, the number of low bit encoders 312 may be the same as the number of high bit encoders 311. The low bit encoders 312 may compress bit sequences corresponding to different bit positions.

The low bit encoder 312 counts the values included in the low bit plane LBP using a zero count circuit ZCC and a one count circuit OCC. The zero count circuit ZCC counts the zero values in the low bit plane LBP, and the result of the count is stored in a third register Reg3. The one count circuit OCC counts the one values in the low bit plane LBP, and the result of the count is stored in a fourth register Reg4.

The low bit encoder 312 generates a valid signal VD through a second validity detection circuit VDC2. If the sum of the zero count and the one count results equals the chunk size CS, it is determined that all values in the low bit plane LBP have been counted, and the second validity detection circuit VDC2 generates the valid signal VD. The low bit encoder 312 may determine the representative value LD as the greater of the zero count and one count results through a bit decision circuit BDC. When the valid signal VD is output to a bit FIFO F3, the representative value LD is stored in the bit FIFO F3. In other words, the low bit plane LBP is compressed using the most frequent bit value.

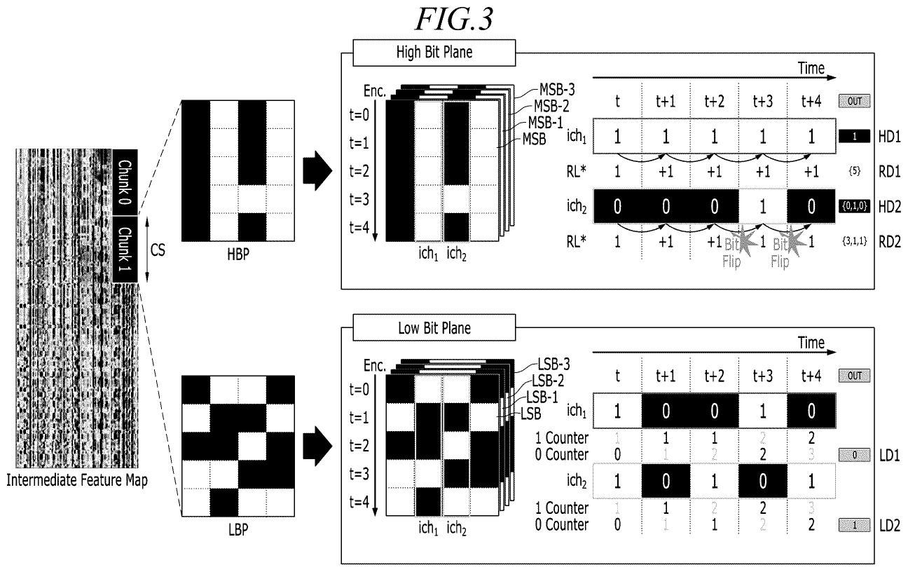

FIG. 3 is a diagram illustrating a chunk-based compression operation of the compression encoder shown in FIG. 2. Referring to FIG. 3, the intermediate feature map includes a plurality of chunks having a chunk size CS. As described above, each chunk may be divided into a high bit plane HBP and a low bit plane LBP. By way of example, it may be understood that the bit planes are separated by bit positions (MSB, MSB-1, . . . , LSB+1, LSB) for a chunk defined by four input channels ich and a bit sequence size of five.

The high bit plane HBP may be run-length encoded for each bit sequence input to the respective channels. The run-length encoding may be performed by the high bit encoder 311 of the compression encoder 310 shown in FIG. 2. For example, a bit sequence (1, 1, 1, 1, 1) corresponding to a first channel ich1 may be input to the high bit encoder 311. Accordingly, the bit value HD1 of 1 is stored in the data FIFO F1, and the run-length count value RD1 of 5 is stored in the run-length FIFO F2. In an example, a bit sequence (0, 0, 0, 1, 0) corresponding to a second channel ich2 may be input to the high bit encoder 311. Accordingly, the bit values HD2 of {0, 1, 0} are stored in the data FIFO F1, and the run-length count values RD2 of {3, 1, 1} are stored in the run-length FIFO F2. These run-length count values RD1, RD2 constitute the compressed data for the high positional bits.

The low bit plane LBP may be run-length encoded for each bit sequence input to the respective channels. The run-length encoding may be performed by the low bit encoder 312 of the compression encoder 310 shown in FIG. 2. For example, a bit sequence (1, 0, 0, 1, 0) corresponding to a first channel ich1 may be input to the low bit encoder 312. Accordingly, the representative value LD1 of 0 is stored in the bit FIFO F3. In an example, a bit sequence (1, 0, 1, 0, 1) corresponding to a second channel ich2 may be input to the low bit encoder 312. As a result, the representative value LD2 of 1 is stored in the bit FIFO F3. These representative values LD1, LD2 constitute the compressed data for the low positional bits.

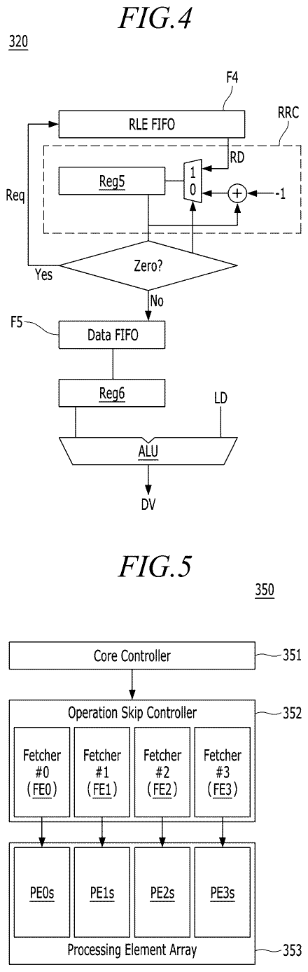

FIG. 4 is a diagram illustrating an exemplary configuration of the compression decoder shown in FIG. 1. The compression decoder 320 of FIG. 4 corresponds to the compression decoder 320 of the core cluster 300 shown in FIG. 1. Furthermore, the compression decoder 320 of FIG. 4 also corresponds to the compression decoder 220 of the convolution core 200 shown in FIG. 1. Referring to FIG. 4, the compression decoder 320 receives run-length count values RD—that is, compressed data of the high positional bits—via a run-length buffer F4. The compression decoder 320 also receives representative values LD—that is, compressed data of the low positional bits—stored in the bit FIFO F3 of FIG. 3. The representative value LD may serve as a bias that is updated only once during the decoding process in the compression decoder 320.

The compression decoder 320 may store the run-length count value RD while decrementing it by one through a run-length register circuit RRC that includes a fifth register Reg5. Until the value stored in the fifth register Reg5 becomes zero, the run-length register circuit RRC may output the same value to a data FIFO F5. Thereafter, the run-length register circuit RRC receives the next run-length count value RD and outputs the updated value to the data FIFO F5 while decrementing it by one.

The data FIFO F5 of the compression decoder 320 sequentially outputs bit values to a sixth register Reg6. The bit values stored in the sixth register Reg6 may represent the decompressed result of the high positional bits. The bit values stored in the sixth register Reg6 may be shifted to their respective bit positions through an arithmetic logic unit ALU and then added to the representative value LD to generate decoded data DV. The decoded data DV may constitute an intermediate feature map including the decompressed chunks.

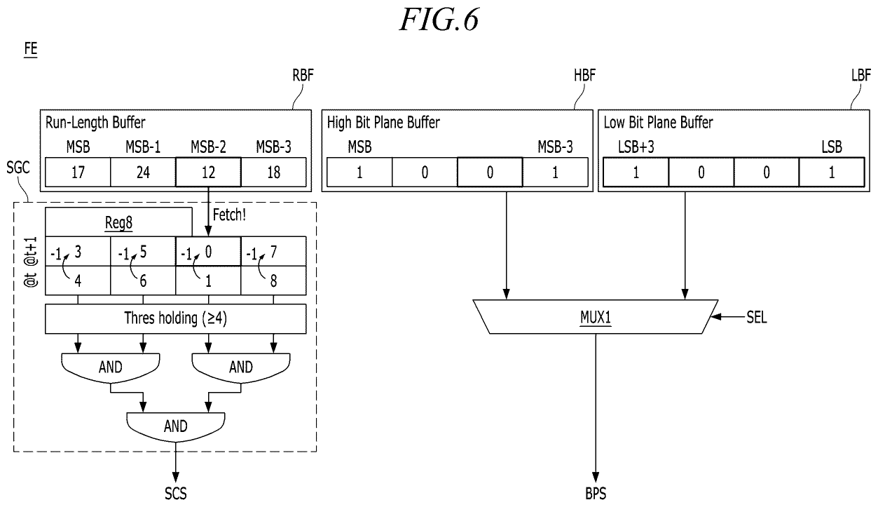

FIG. 5 is a diagram illustrating an exemplary configuration of the core shown in FIG. 1. Referring to FIG. 5, a core 350 corresponds to one of the cores 350 of the core cluster 300 shown in FIG. 1. The core 350 may include a core controller 351, an operation skip controller 352, and a processing element array 353.

The core controller 351 may perform control for the overall operation of the core 350. The core controller 351 may generate control signals for the operation of the operation skip controller 352 and the processing element array 353. For example, the core controller 351 may generate a selection signal to select one of the bit planes—either the high bit plane HBP or the low bit plane LBP—as the target for processing.

The operation skip controller 352 may generate skip signals to skip parts of the matrix multiplication operation based on the similarity within the intermediate feature map. The operation skip controller 352 may determine a skip range using the run-length count values derived from compression of the high bit plane HBP and generate skip signals corresponding to that skip range. The operation skip controller 352 includes fetchers FE0-FE3. The number of fetchers FE0-FE3 depends on the number of input channels used for parallel processing as previously described. For example, each of the fetchers FE0-FE3 may correspond to one of the four input channels shown in FIG. 5.

The fetchers FE0-FE3 may generate skip control signals for skipping portions of the matrix multiplication corresponding to specific channels based on the length information included in the compressed data of the high bit plane HBP. The fetchers FE0-FE3 may receive compressed data of either the high bit plane HBP or the low bit plane LBP from the corresponding channel and output the compressed data determined by the selection signal of the core controller 351 to the processing element array 353.

The processing element array 353 includes a plurality of processing elements PE0s-PE3s. The number of processing elements PE0s-PE3s depends on the number of input channels described above. For example, each set of processing elements PE0s-PE3s corresponds to one of the four input channels. A single channel may be connected to multiple processing elements. For instance, there may be eight processing elements PE1s connected to a first channel, in which case, the total number of processing elements PE0s-PE3s may be 32, with eight processing elements assigned to each of the four channels.

The processing elements PE0s-PE3s perform matrix multiplication between the intermediate feature map and the weights. The processing elements PE0s-PE3s may receive some data of the intermediate feature map in parallel through the four channels from the fetchers FE0-FE3 and perform matrix multiplication between the received data and the weights. The results of the matrix multiplication may be accumulated and aggregated as the final output, which may be understood to constitute part of a subsequent feature map.

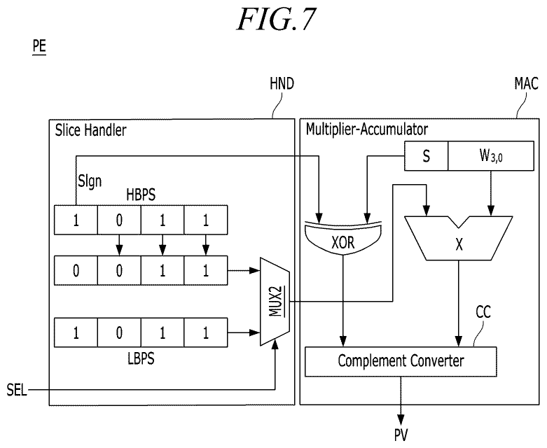

FIG. 6 is a diagram illustrating an exemplary configuration of the fetcher shown in FIG. 5. The fetcher FE in FIG. 6 corresponds to one of the fetchers FE0-FE3 shown in FIG. 5. Referring to FIG. 6, the fetcher FE may include a run-length buffer RBF, a high bit plane buffer HBF, a low bit plane buffer LBF, a skip signal generation circuit SGC, and a multiplexer MUX1.

The run-length buffer RBF stores length information for each bit position. The length information represents the number of consecutive identical values at each bit position of the high positional bits. This length information indicates the degree of repetition of identical values along the column direction (input time direction or token direction) in the matrix multiplication operation. When rows have identical values, the same result is computed in the matrix multiplication with weights, and thus operations during the repeated section can be skipped, and the precomputed result may be reused in other computations. The length information for each bit position is stored in a register Reg8 of the skip signal generation circuit SGC.

The high bit plane buffer HBF stores the high bit plane HBP described above, and the low bit plane buffer LBF stores the low bit plane LBP described above. The multiplexer MUX1 selects one of the high bit plane HBP and the low bit plane LBP based on a selection signal SEL generated by the core controller 351, and outputs a bit plane slice signal BPS, which is a portion of the selected bit plane, to the processing element array 353.

The skip signal generation circuit SGC decreases the values stored in the register Reg8 based on the output of the bit plane slice signal BPS. The skip signal generation circuit SGC continues to decrement the stored values until the value corresponding to at least one of the positions becomes zero, at which time the value of the corresponding position is newly received from the run-length buffer RBF. For example, when the bit plane slice signal BPS is output, the skip signal generation circuit SGC may decrement the values corresponding to four bit positions by one each and generate a skip control signal SCS through AND gates. If at least one of the values becomes zero and the total decrement is less than four, it indicates that the same values are not consecutive, and therefore the skip control signal SCS is not generated. In other words, the skip signal generation circuit SGC may perform a skip operation that improves the efficiency of matrix multiplication using length information derived from the compressed data.

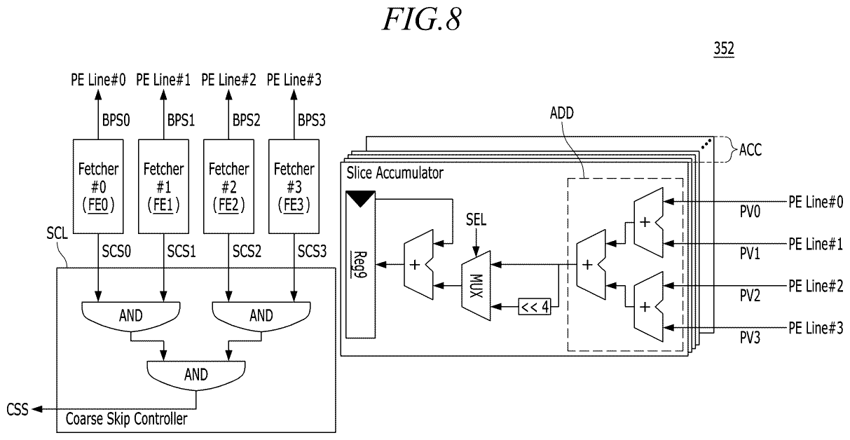

FIG. 7 is a diagram illustrating an exemplary configuration of a processing element shown in FIG. 5. The processing element PE in FIG. 7 corresponds to one of the processing elements PE0-PE3 of FIG. 5. Referring to FIG. 7, the processing element PE may include a slice handler HND and a multiplier-accumulator MAC. The processing elements PE may utilize a weight-stationary data flow.

The slice handler HND may receive a bit plane slice signal BPS from the fetcher FE shown in FIG. 6. The bit plane slice signal BPS may be 4-bit slice data. A multiplexer MUX2 in the slice handler HND may output the bit plane slice signal BPS to the multiplier-accumulator MAC based on a selection signal SEL. The selection signal SEL may be generated by the core controller 351 shown in FIG. 5. The selection signal SEL may indicate whether the bit plane slice signal BPS belongs to the high bit plane HBP or the low bit plane LBP.

The multiplier-accumulator MAC performs operations between the received bit plane slice signal BPS and weights. If the bit plane slice signal BPS belongs to the high bit plane HBP, the slice handler HND separates the bit plane slice signal BPS into a sign part and a magnitude part. The slice handler HND expands the magnitude part to the number of unseparated bits (4 bits). The expanded magnitude part is multiplied with the magnitude part of the weight by the multiplier circuit of the multiplier-accumulator MAC. The separated sign part is XORed with the sign part of the weight by the multiplier-accumulator MAC. The computed sign and magnitude parts are combined by a complement converter CC of the multiplier-accumulator MAC and converted into two's complement representation. The resulting processed value PV is accumulated.

If the bit plane slice signal BPS belongs to the low bit plane LBP, the slice handler HND outputs the bit plane slice signal BPS to the multiplier-accumulator MAC without separating it into sign and magnitude parts. The multiplier-accumulator MAC multiplies the bit plane slice signal BPS with the weight and appends a zero-extended sign bit. The processing result PV for the low bit plane LBP may be calculated during the initial cycle of the chunk operation. Since the low bit plane LBP is replaced with a representative value, the processing result PV may be reused across the entire chunk.

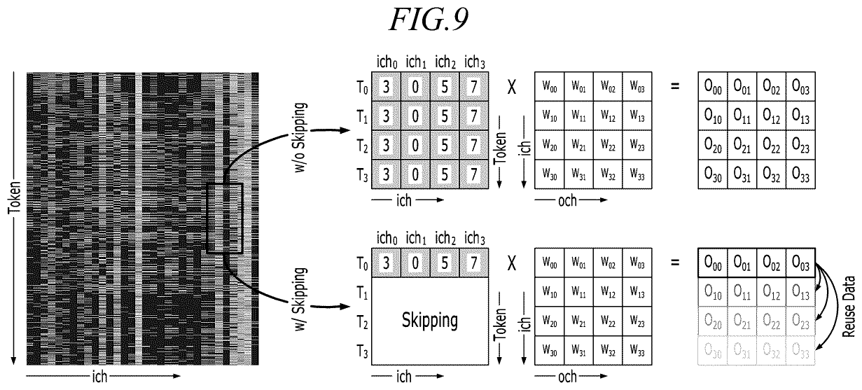

FIG. 8 is a diagram illustrating an exemplary configuration of the operation skip controller shown in FIG. 5. Referring to FIG. 8, the operation skip controller 352 includes fetchers FE0-FE3, a coarse skip controller SCL, and a slice accumulator ACC. The fetchers FE0-FE3 correspond to the fetchers FE0-FE3 shown in FIG. 5 and, as described with reference to FIG. 6, may generate skip control signals SCS0-SCS3 based on the length information for each bit position. The fetchers FE0-FE3 may output bit plane slice signals BPS0-BPS3 via the channel lines connected to the corresponding processing elements.

The coarse skip controller SCL may generate a skip signal CSS by performing an AND operation on all skip control signals SCS0-SCS3. Based on the skip signal CSS, the processing elements connected to the channel lines skip matrix multiplication operations. During this skip, the operation skip controller 352 may reuse previously computed processing results PV0-PV3 for accumulation.

The slice accumulator ACC receives processing results PV0-PV3 from the channel lines connected to the processing elements. The slice accumulator ACC accumulates these processing results PV0-PV3. Multiple instances of the slice accumulator ACC may be provided to accumulate the processing results PV0-PV3 for each processing element per channel. For example, there may be 32 slice accumulators ACC corresponding to the number of processing elements connected to each channel line.

The slice accumulator ACC performs an addition operation on the processing results PV0-PV3 through an adder ADD configured as a two-stage addition tree. The slice accumulator ACC shifts the processing results PV0-PV3 by 4 bits when corresponding to the high bit plane HBP. The slice accumulator ACC selectively outputs the shifted processing results PV0-PV3 corresponding to the high bit plane HBP and the processing results PV0-PV3 corresponding to the low bit plane LBP based on the selection signal SEL. The outputted processing results PV0-PV3 are accumulated and stored in a register Reg9.

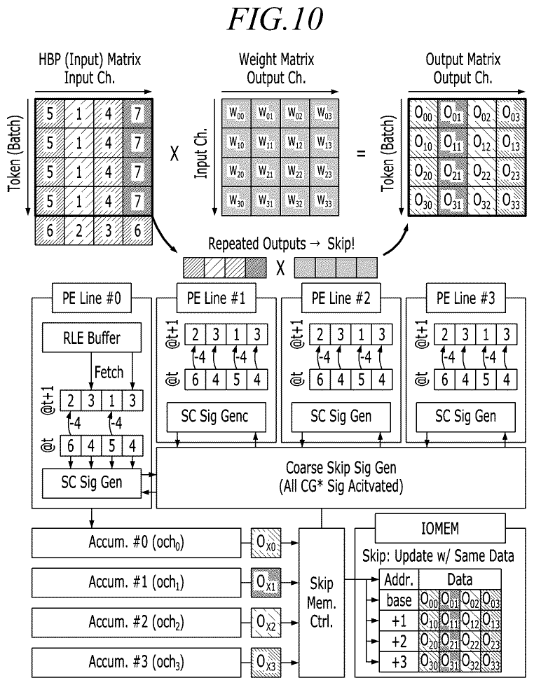

FIG. 9 is a diagram illustrating a similarity-based skip operation performed by the core shown in FIG. 5. The core 350 of FIG. 5 is configured to skip redundant operations during matrix multiplication based on similarity characteristics observed in the intermediate feature map of a Mixed Transformer (MiT) model. Referring to FIG. 9, the row direction may be understood as the direction of the channel array described above, and the column direction may be understood as the token direction or the direction of the input sequence.

When the same value is repeatedly input for each channel, the result of matrix multiplication with the weights may yield repeated values along the column direction. Therefore, the operation skip controller 352 of the core 350 may reuse the result of certain operations in the matrix multiplication for other operations. As a result, computational processing time and power consumption due to redundant operations may be reduced, and computation throughput per unit time may be increased.

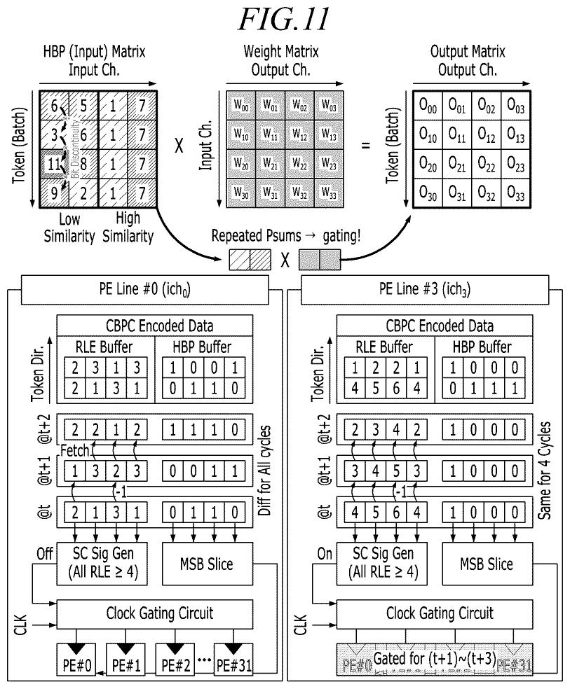

FIG. 10 is a diagram illustrating a coarse skip operation performed by the core shown in FIG. 5. Referring to FIG. 10, the core 350 determines data repetition in the token direction based on the length information (run-length count values) corresponding to each channel. When the run-length count values for all bit positions exceed a threshold, the core reduces the run-length count value for each bit position by the threshold amount and activates the skip control signal. When skip control signals corresponding to all channels are activated, matrix multiplication operations for subsequent rows are skipped in a coarse skip operation. The computation is performed only once, and the result is copied and recorded in the input/output memory.

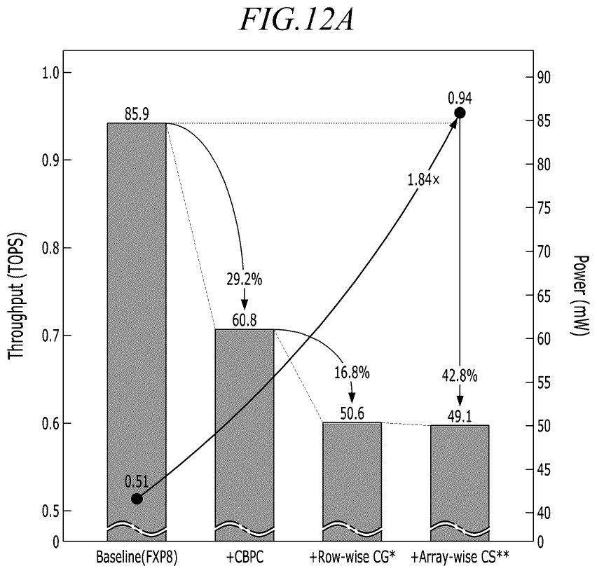

FIG. 11 is a diagram illustrating a fine skip operation performed by the core shown in FIG. 5. Referring to FIG. 11, the core 350 determines data repetition in the token direction based on the length information (run-length count values) corresponding to each channel. When at least one of the run-length count values among multiple channel lines exceeds a threshold at certain bit positions, the channel line processing the corresponding data is subjected to clock gating. The clock gating may be controlled by the skip control signal SCS. When the skip control signal SCS indicates skipping, clock gating may be performed. During clock gating, matrix multiplication operations for the corresponding channel line may be skipped. That is, processing elements for channel lines with low similarity may perform matrix multiplication, and processing elements for channel lines with high similarity may skip at least part of the matrix multiplication operations.

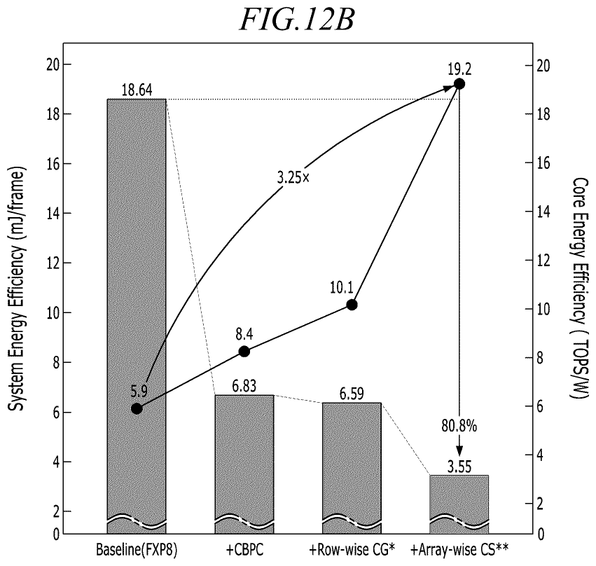

FIGS. 12A and 12B are graphs illustrating computational efficiency achieved by the compression and skip operations of the present disclosure. Referring to FIG. 12A, compared to the case in which no functions are applied, matrix multiplication throughput is increased by 1.84 times and power consumption is reduced by 42.8% every time chunk-based bit plane compression (CBPC), coarse skip operation (CG*), or fine skip operation (CS**) is added. Referring to FIG. 12B, compared to the case in which no functions are applied, CBPC, CG*, and CS** increases core energy efficiency is increased by 3.25 times and energy consumption per frame is reduced by 80.8% every time chunk-based bit plane compression (CBPC), coarse skip operation (CG*), or fine skip operation (CS**) is added. As a result, by applying the compression and skip operations of the present disclosure, the image signal processor 1000 may achieve an energy efficiency of 3.55 mJ/frame and a processing speed of 77.5 FPS when performing image segmentation.

While certain exemplary embodiments have been described, it shall be appreciated by those skilled in the art that various modifications and alterations are possible without departing from the technical ideas and scope of the disclosure as set forth in the claims below. The embodiments disclosed herein are not intended to limit the technical ideas of the present disclosure, and all technical concepts and ideas falling within the scope of the claims and their equivalents are to be construed as being within the scope of the present disclosure.

1. An image signal processor comprising:
a network interface configured to receive image data;
a convolution core configured to perform convolution operations on the image data to generate an intermediate feature map comprising chunks; and
a core cluster configured to perform matrix multiplication between the intermediate feature map and weights,
wherein the core cluster comprises:
a compression encoder configured to compress first positional bits of each of the chunks into first data based on run-length encoding and to compress second positional bits, which are lower than the first positional bits of each of the chunks, into second data based on an encoding different from the run-length encoding; and
a plurality of cores configured to reuse results of certain operations in the matrix multiplication between the first positional bits and the weights, during other operations of the matrix multiplication, based on the first data.

2. The image signal processor of claim 1, wherein the compression encoder comprises:
a high bit encoder configured to generate the first data comprising length information representing a number of consecutive identical values at each position of the first positional bits; and
a low bit encoder configured to generate the second data comprising a representative value corresponding to the most frequent value at each position of the second positional bits.

3. The image signal processor of claim 2, wherein each of the chunks has a size dependent on a number of channels input in parallel to each of the cores, and
wherein the length information comprises a number of consecutively input identical bit values at a specific position of the first positional bits for a specific channel among the channels.

4. The image signal processor of claim 1, wherein the first positional bits comprise bits that are in an upper half relative to a total number of bits in each of the chunks, and the second positional bits comprise bits that are in a lower half relative to the total number of bits.

5. The image signal processor of claim 1, wherein the core cluster further comprises a compression decoder configured to decode the first data into the first positional bits of the intermediate feature map and concatenate the decoded first data with the second data.

6. The image signal processor of claim 1, wherein each of the cores comprises:
a fetcher configured to generate a skip control signal for the reuse based on the first data, receive the first data and the second data from the compression encoder, and selectively output either the first data or the second data; and
a processing element configured to receive the first data or the second data from the fetcher, perform matrix multiplication between the received first or second data and the weights, and skip the other operations in the matrix multiplication based on the skip control signal.

7. The image signal processor of claim 6, wherein the fetcher is configured to store the first data comprising length information representing a number of consecutive identical values at each position of the first positional bits, determine a skip range for skipping the other operations based on length information at a position having the smallest value among the first positional bits, and generate the skip control signal corresponding to the skip range.

8. The image signal processor of claim 6, wherein the processing element is configured to separate the first data into a sign part and a magnitude part, perform an XOR operation between the sign part and a sign part of the weights, perform a multiplication between the magnitude part and a magnitude part of the weights, and combine a result of the XOR operation and a result of the multiplication.

9. The image signal processor of claim 6, wherein the processing element is configured to perform a multiplication between the second data and the weights and append a sign bit to a result of the multiplication.

10. The image signal processor of claim 1, wherein each of the chunks has a size dependent on a number of channels input in parallel to each of the cores, and
wherein each of the cores is configured to receive the first data and the second data corresponding respectively to the channels from the compression encoder, generate a skip signal corresponding to a specific channel among the channels based on the first data, and skip at least a part of the matrix multiplication corresponding to the specific channel based on the skip signal.
